(19) United States
(12) Patent Application Publication
(10) Pub. No.: US 2017/0279685 A1
(43) Pub. Date: Sep. 28, 2017

(54) ADJUSTING ANOMALY DETECTION OPERATIONS BASED ON NETWORK RESOURCES

(71) Applicant: Cisco Technology, Inc., San Jose, CA (US)

(72) Inventors: Javier Cruz Mota, Assens (CH); Grégory Mermoud, Veyras (CH); Jean-Philippe Vasseur, Anchorage, AK (US); Fabien Flacher, Antony (FR)

(21) Appl. No.: 15/212,617

(22) Filed: Jul. 18, 2016

Related U.S. Application Data
(60) Provisional application No. 62/313,172, filed on Mar. 25, 2016.

(51) Int. Cl. H04L 12/24; H04L 29/08; H04L 29/06; H04L 12/26

(52) U.S. Cl. CPC H04L 41/12; H04L 43/08; H04L 41/046; H04L 67/02; H04L 63/1425; H04L 63/145; H04L 63/1458

(57) ABSTRACT

In one embodiment, a device in a network monitors a selective anomaly forwarding mechanism deployed in the network. The selective anomaly forwarding mechanism causes a participating node in the mechanism to selectively forward detected network anomalies to the device. The device monitors one or more resources of the network. The device determines an adjustment to the selective anomaly forwarding mechanism based on the one or more monitored resources of the network. The device implements the determined adjustment to the selective anomaly forwarding mechanism.

### RELATED APPLICATION

This application claims priority to U.S. Provisional Application No. 62/313,172, filed on Mar. 25, 2016, entitled ADJUSTING ANOMALY DETECTION OPERATIONS BASED ON NETWORK RESOURCES, by Cruz Mota, et al., the contents of which are herein incorporated by reference.

### TECHNICAL FIELD

The present disclosure relates generally to computer networks, and, more particularly, to adjusting anomaly detection operations based on network resources.

### BACKGROUND

Enterprise networks are carrying a very fast growing volume of both business and non-business critical traffic. Often, business applications such as video collaboration, cloud applications, etc., use the same hypertext transfer protocol (HTTP) and/or HTTP secure (HTTPS) techniques that are used by non-business critical web traffic. This complicates the task of optimizing network performance for specific applications, as many applications use the same protocols, thus making it difficult to distinguish and select traffic flows for optimization.

One type of network attack that is of particular concern in the context of computer networks is a Denial of Service (DoS) attack. In general, the goal of a DoS attack is to prevent legitimate use of the services available on the network. For example, a DoS jamming attack may artificially introduce interference into the network, thereby causing collisions with legitimate traffic and preventing message decoding. In another example, a DoS attack may attempt to overwhelm the network's resources by flooding the network with requests, to prevent legitimate requests from being processed. A DoS attack may also be distributed, to conceal the presence of the attack. For example, a distributed DoS (DDoS) attack may involve multiple attackers sending malicious requests, making it more difficult to distinguish when an attack is underway. When viewed in isolation, a particular one of such a request may not appear to be malicious. However, in the aggregate, the requests may overload a resource, thereby impacting legitimate requests sent to the resource.

Botnets represent one way in which a DDoS attack may be launched against a network. In a botnet, a subset of the network devices may be infected with malicious software, thereby allowing the devices in the botnet to be controlled by a single master. Using this control, the master can then coordinate the attack against a given network resource.

Distributed learning systems such as self-learning networks (SLN) generally detect anomalies independently of the network resources that are available for sending the information about these anomalies to the centralized agent and/or the user operating the system. One problem with this approach is that the sheer number of statistical deviations detected by the system completely saturates the system (e.g., WAN bandwidth).

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example self learning network (SLN) infrastructure;

FIG. 4 illustrates an example distributed learning agent (DLA) in an SLN:

FIG. 5 illustrates an example architecture for adjusting anomaly detection operations based on network resources;

FIGS. 6A-6B illustrate an example of the selective forwarding of anomalies;

FIGS. 7A-7B illustrate another example of the selective forwarding of anomalies;

FIGS. 8A-8D illustrate examples of a device adjusting anomaly forwarding budgets; and

FIG. 9 illustrates an example simplified procedure for adjusting anomaly detection operating based on network resources.

### DESCRIPTION OF EXAMPLE EMBODIMENTS

### Overview

According to one or more embodiments of the disclosure, a device in a network monitors a selective anomaly forwarding mechanism deployed in the network. The selective anomaly forwarding mechanism causes a participating node in the mechanism to selectively forward detected network anomalies to the device. The device monitors one or more resources of the network. The device determines an adjustment to the selective anomaly forwarding mechanism based on the one or more monitored resources of the network. The device implements the determined adjustment to the selective anomaly forwarding mechanism.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

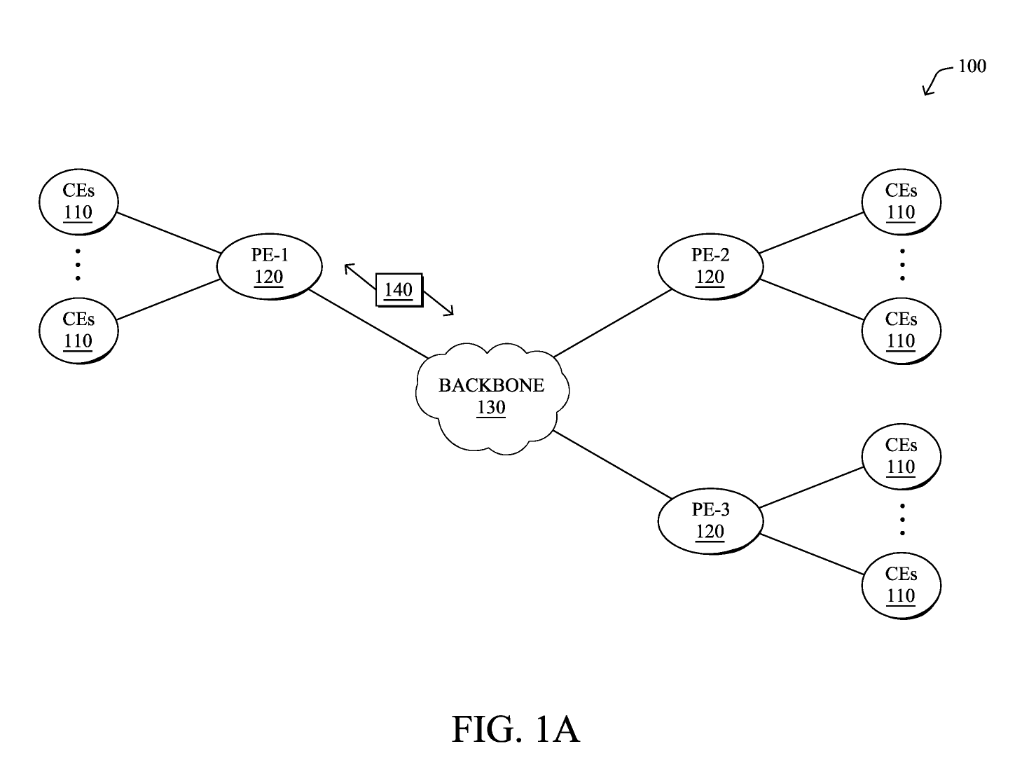

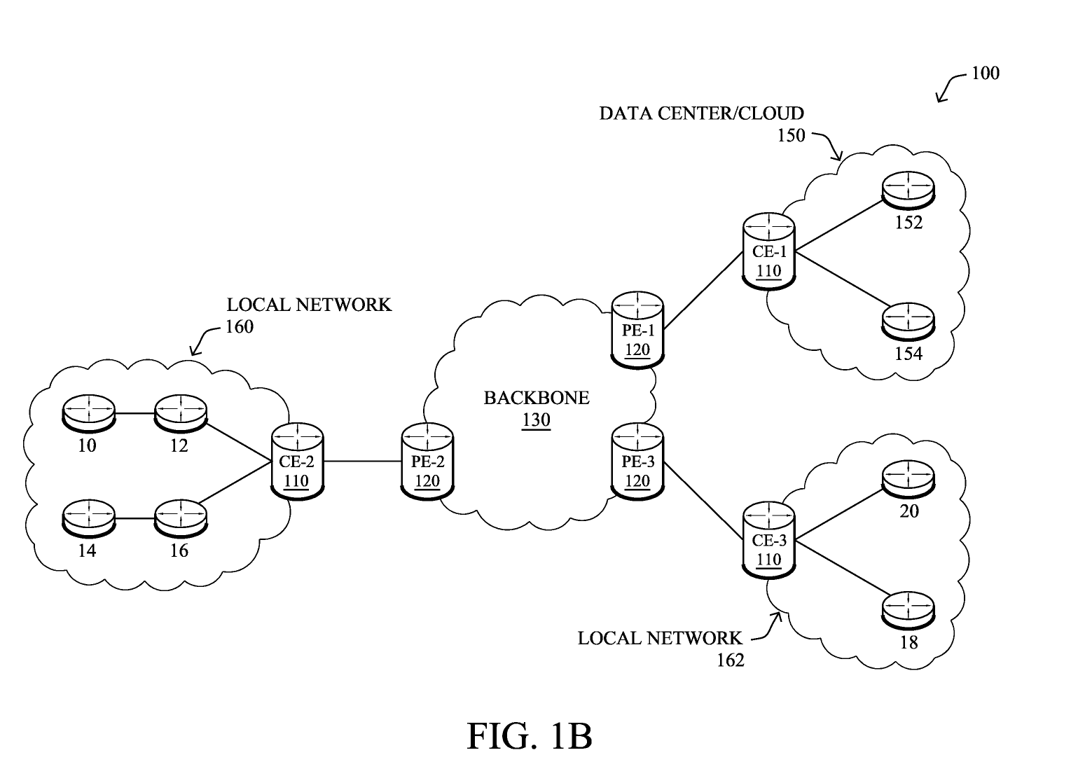

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/LTE backup connection). For example, a particular CE router 110 shown in network 100 may support a given customer site, potentially also with a backup link, such as a wireless connection.

2.) Site Type B: a site connected to the network using two MPLS VPN links (e.g., from different Service Providers), with potentially a backup link (e.g., a 3G/4G/LTE connection). A site of type B may itself be of different types:

2a.) Site Type B1: a site connected to the network using two MPLS VPN links (e.g., from different Service Providers), with potentially a backup link (e.g., a 3G/4G/LTE connection).

2b.) Site Type B2: a site connected to the network using one MPLS VPN link and one link connected to the public Internet, with potentially a backup link (e.g., a 3G/4G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

In various embodiments, network 100 may include one or more mesh networks, such as an Internet of Things network. Loosely, the term “Internet of Things” or “IoT” refers to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Notably, shared-media mesh networks, such as wireless or PLC networks, etc., are often on what is referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen to thousands or even millions of LLN routers, and support point-to-point traffic (between devices inside the LLN), point-to-multipoint traffic (from a central control point such at the root node to a subset of devices inside the LLN), and multipoint-to-point traffic (from devices inside the LLN towards a central control point). Often, an IoT network is implemented with an LLN-like architecture. For example, as shown, local network 160 may be an LLN in which CE-2 operates as a root node for nodes/devices 10-16 in the local mesh, in some embodiments.

In contrast to traditional networks, LLNs face a number of communication challenges. First, LLNs communicate over a physical medium that is strongly affected by environmental conditions that change over time. Some examples include temporal changes in interference (e.g., other wireless networks or electrical appliances), physical obstructions (e.g., doors opening/closing, seasonal changes such as the foliage density of trees, etc.), and propagation characteristics of the physical media (e.g., temperature or humidity changes, etc.). The time scales of such temporal changes can range between milliseconds (e.g., transmissions from other transceivers) to months (e.g., seasonal changes of an outdoor environment). In addition, LLN devices typically use low-cost and low-power designs that limit the capabilities of their transceivers. In particular, LLN transceivers typically provide low throughput. Furthermore, LLN transceivers typically support limited link margin, making the effects of interference and environmental changes visible to link and network protocols. The high number of nodes in LLNs in comparison to traditional networks also makes routing, quality of service (QoS), security, network management, and traffic engineering extremely challenging, to mention a few.

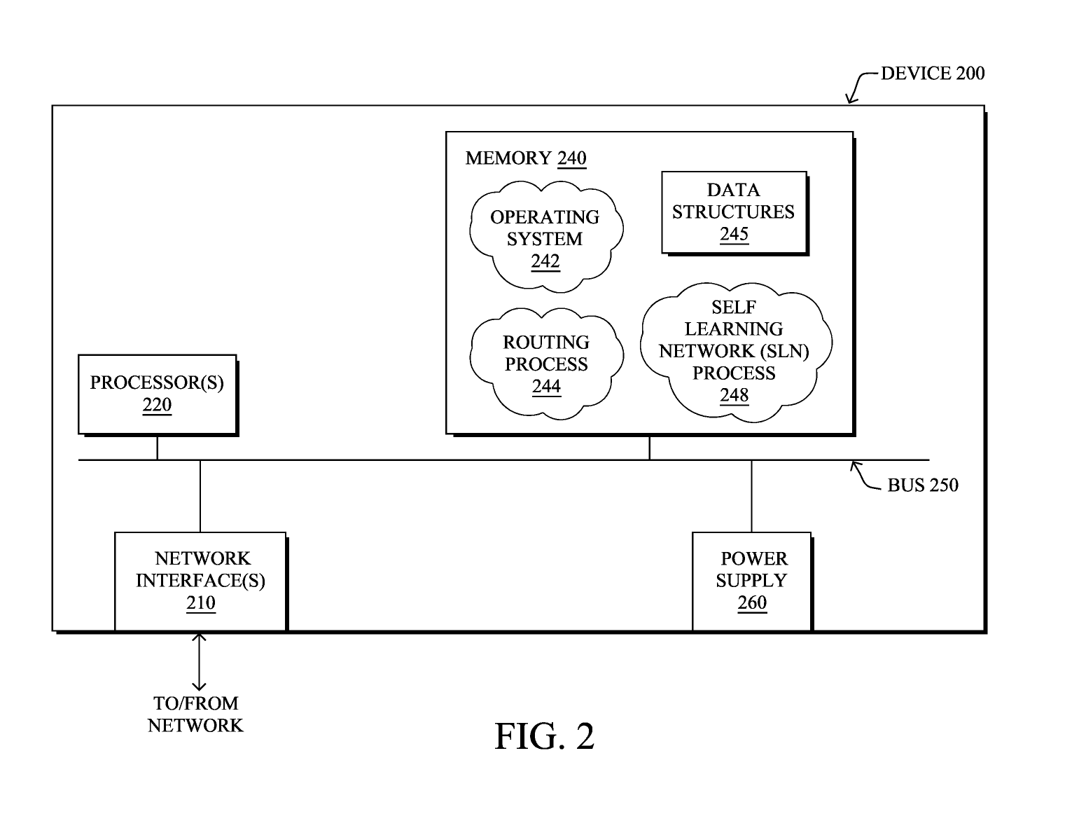

FIG. 2 is a schematic block diagram of an example node/device 200 that may be used with one or more embodiments described herein, e.g., as any of the computing devices shown in FIGS. 1A-1B, particularly the PE routers 120, CE routers 110, nodes/device 10-20, servers 152-154 (e.g., a network controller located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise routing process 244 (e.g., routing services) and illustratively, a self learning network (SLN) process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

Routing process/services 244 include computer executable instructions executed by processor 220 to perform functions provided by one or more routing protocols, such as the Interior Gateway Protocol (IGP) (e.g., Open Shortest Path First, “OSPF,” and Intermediate-System-to-Intermediate-System, “IS-IS”), the Border Gateway Protocol (BGP), etc., as will be understood by those skilled in the art. These functions may be configured to manage a forwarding information database including, e.g., data used to make forwarding decisions. In particular, changes in the network topology may be communicated among routers 200 using routing protocols, such as the conventional OSPF and IS-IS link-state protocols (e.g., to “converge” to an identical view of the network topology).

Notably, routing process 244 may also perform functions related to virtual routing protocols, such as maintaining VRF instance, or tunneling protocols, such as for MPLS, generalized MPLS (GMPLS), etc., each as will be understood by those skilled in the art. Also, EVPN, e.g., as described in the IETF Internet Draft entitled “BGP MPLS Based Ethernet VPN”<draft-ietf-l2vpn-evpn>, introduce a solution for multipoint L2VPN services, with advanced multi-homing capabilities, using BGP for distributing customer/client media access control (MAC) address reach-ability information over the core MPLS/IP network.

SLN process 248 includes computer executable instructions that, when executed by processor(s) 220, cause device 200 to perform anomaly detection functions as part of an anomaly detection infrastructure within the network. In general, anomaly detection attempts to identify patterns that do not conform to an expected behavior. For example, in one embodiment, the anomaly detection infrastructure of the network may be operable to detect network attacks (e.g., DDoS attacks, the use of malware such as viruses, rootkits, etc.). However, anomaly detection in the context of computer networking typically presents a number of challenges: 1.) a lack of a ground truth (e.g., examples of normal vs. abnormal network behavior), 2.) being able to define a “normal” region in a highly dimensional space can be challenging, 3.) the dynamic nature of the problem due to changing network behaviors/anomalies, 4.) malicious behaviors such as malware, viruses, rootkits, etc. may adapt in order to appear “normal,” and 5.) differentiating between noise and relevant anomalies is not necessarily possible from a statistical standpoint, but typically also requires domain knowledge.

Anomalies may also take a number of forms in a computer network: 1.) point anomalies (e.g., a specific data point is abnormal compared to other data points), 2.) contextual anomalies (e.g., a data point is abnormal in a specific context but not when taken individually), or 3.) collective anomalies (e.g., a collection of data points is abnormal with regards to an entire set of data points). Generally, anomaly detection refers to the ability to detect an anomaly that could be triggered by the presence of malware attempting to access data (e.g., data exfiltration), spyware, ransom-ware, etc. and/or non-malicious anomalies such as misconfigurations or misbehaving code. Particularly, an anomaly may be raised in a number of circumstances:
Security threats: the presence of a malware using unknown attacks patterns (e.g., no static signatures) may lead to modifying the behavior of a host in terms of traffic patterns, graphs structure, etc. Machine learning processes may detect these types of anomalies using advanced approaches capable of modeling subtle changes or correlation between changes (e.g., unexpected behavior) in a highly dimensional space. Such anomalies are raised in order to detect, e.g., the presence of a 0-day malware, malware used to perform data ex-filtration thanks to a Command and Control (C2) channel, or even to trigger (Distributed) Denial of Service (DoS) such as DNS reflection, UDP flood, HTTP recursive get, etc. In the case of a (D)DoS, although technical an anomaly, the term “DoS” is usually used.
   SLN process 248 may detect malware based on the corresponding impact on traffic, host models, graph-based analysis, etc., when the malware attempts to connect to a C2 channel, attempts to move laterally, or exfiltrate information using various techniques.
Misbehaving devices: a device such as a laptop, a server of a network device (e.g., storage, router, switch, printer, etc.) may misbehave in a network for a number of reasons: 1.) a user using a discovery tool that performs (massive) undesirable scanning in the network (in contrast with a lawful scanning by a network management tool performing device discovery), 2.) a software defect (e.g. a switch or router dropping packet because of a corrupted RIB/FIB or the presence of a persistent loop by a routing protocol hitting a corner case).
Dramatic behavior change: the introduction of a new networking or end-device configuration, or even the introduction of a new application may lead to dramatic behavioral changes. Although technically not anomalous, an SLN-enabled node having computed behavioral model(s) may raise an anomaly when detecting a brutal behavior change. Note that in such as case, although an anomaly may be raised, a learning system such as SLN is expected to learn the new behavior and dynamically adapts according to potential user feedback.
Misconfigured devices: a configuration change may trigger an anomaly: a misconfigured access control list (ACL), route redistribution policy, routing policy, QoS policy maps, or the like, may have dramatic consequences such a traffic black-hole, QoS degradation, etc. SLN process 248 may advantageously identify these forms of misconfigurations, in order to be detected and fixed.

In various embodiments, SLN process 248 may utilize machine learning techniques, to perform anomaly detection in the network. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

Computational entities that rely on one or more machine learning techniques to perform a task for which they have not been explicitly programmed to perform are typically referred to as learning machines. In particular, learning machines are capable of adjusting their behavior to their environment. For example, a learning machine may dynamically make future predictions based on current or prior network measurements, may make control decisions based on the effects of prior control commands, etc.

For purposes of anomaly detection in a network, a learning machine may construct a model of normal network behavior, to detect data points that deviate from this model. For example, a given model (e.g., a supervised, un-supervised, or semi-supervised model) may be used to generate and report anomaly scores to another device. Example machine learning techniques that may be used to construct and analyze such a model may include, but are not limited to, nearest neighbor (NN) techniques (e.g., k-NN models, replicator NN models, etc.), statistical techniques (e.g., Bayesian networks, etc.), clustering techniques (e.g., k-means, etc.), neural networks (e.g., reservoir networks, artificial neural networks, etc.), support vector machines (SVMs), or the like.

One class of machine learning techniques that is of particular use in the context of anomaly detection is clustering. Generally speaking, clustering is a family of techniques that seek to group data according to some typically predefined notion of similarity. For instance, clustering is a very popular technique used in recommender systems for grouping objects that are similar in terms of people's taste (e.g., because you watched X, you may be interested in Y, etc.). Typical clustering algorithms are k-means, density based spatial clustering of applications with noise (DBSCAN) and mean-shift, where a distance to a cluster is computed with the hope of reflecting a degree of anomaly (e.g., using a Euclidian distance and a cluster based local outlier factor that takes into account the cluster density).

Replicator techniques may also be used for purposes of anomaly detection. Such techniques generally attempt to replicate an input in an unsupervised manner by projecting the data into a smaller space (e.g., compressing the space, thus performing some dimensionality reduction) and then reconstructing the original input, with the objective of keeping the “normal” pattern in the low dimensional space. Example techniques that fall into this category include principal component analysis (PCA) (e.g., for linear models), multi-layer perceptron (MLP) ANNs (e.g., for non-linear models), and replicating reservoir networks (e.g., for non-linear models, typically for time series).

According to various embodiments, SLN process 248 may also use graph-based models for purposes of anomaly detection. Generally speaking, a graph-based model attempts to represent the relationships between different entities as a graph of nodes interconnected by edges. For example, ego-centric graphs have been used to represent the relationship between a particular social networking profile and the other profiles connected to it (e.g., the connected “friends” of a user, etc.). The patterns of these connections can then be analyzed for purposes of anomaly detection. For example, in the social networking context, it may be considered anomalous for the connections of a particular profile not to share connections, as well. In other words, a person's social connections are typically also interconnected. If no such interconnections exist, this may be deemed anomalous.

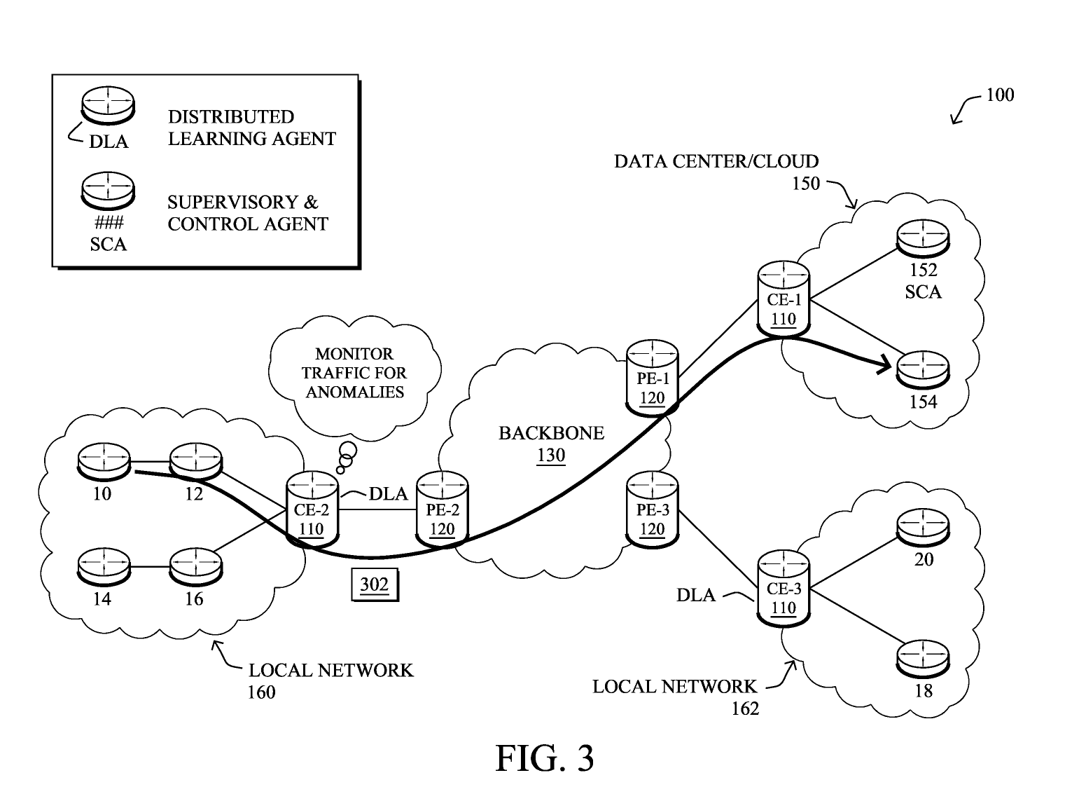

An example self learning network (SLN) infrastructure that may be used to detect network anomalies is shown in FIG. 3, according to various embodiments. Generally, network devices may be configured to operate as part of an SLN infrastructure to detect, analyze, and/or mitigate network anomalies such as network attacks (e.g., by executing SLN process 248). Such an infrastructure may include certain network devices acting as distributed learning agents (DLAs) and one or more supervisory/centralized devices acting as a supervisory and control agent (SCA). A DLA may be operable to monitor network conditions (e.g., router states, traffic flows, etc.), perform anomaly detection on the monitored data using one or more machine learning models, report detected anomalies to the SCA, and/or perform local mitigation actions. Similarly, an SCA may be operable to coordinate the deployment and configuration of the DLAs (e.g., by downloading software upgrades to a DLA, etc.), receive information from the DLAs (e.g., detected anomalies/attacks, compressed data for visualization, etc.), provide information regarding a detected anomaly to a user interface (e.g., by providing a webpage to a display, etc.), and/or analyze data regarding a detected anomaly using more CPU intensive machine learning processes.

One type of network attack that is of particular concern in the context of computer networks is a Denial of Service (DoS) attack. In general, the goal of a DoS attack is to prevent legitimate use of the services available on the network. For example, a DoS jamming attack may artificially introduce interference into the network, thereby causing collisions with legitimate traffic and preventing message decoding. In another example, a DoS attack may attempt to overwhelm the network's resources by flooding the network with requests (e.g., SYN flooding, sending an overwhelming number of requests to an HTTP server, etc.), to prevent legitimate requests from being processed. A DoS attack may also be distributed, to conceal the presence of the attack. For example, a distributed DoS (DDoS) attack may involve multiple attackers sending malicious requests, making it more difficult to distinguish when an attack is underway. When viewed in isolation, a particular one of such a request may not appear to be malicious. However, in the aggregate, the requests may overload a resource, thereby impacting legitimate requests sent to the resource.

Botnets represent one way in which a DDoS attack may be launched against a network. In a botnet, a subset of the network devices may be infected with malicious software, thereby allowing the devices in the botnet to be controlled by a single master. Using this control, the master can then coordinate the attack against a given network resource.

DoS attacks are relatively easy to detect when they are brute-force (e.g. volumetric), but, especially when highly distributed, they may be difficult to distinguish from a flash-crowd (e.g., an overload of the system due to many legitimate users accessing it at the same time). This fact, in conjunction with the increasing complexity of performed attacks, makes the use of “classic” (usually threshold-based) techniques useless for detecting them. However, machine learning techniques may still be able to detect such attacks, before the network or service becomes unavailable. For example, some machine learning approaches may analyze changes in the overall statistical behavior of the network traffic (e.g., the traffic distribution among flow flattens when a DDoS attack based on a number of microflows happens). Other approaches may attempt to statistically characterizing the normal behaviors of network flows or TCP connections, in order to detect significant deviations. Classification approaches try to extract features of network flows and traffic that are characteristic of normal traffic or malicious traffic, constructing from these features a classifier that is able to differentiate between the two classes (normal and malicious).

As shown in FIG. 3, routers CE-2 and CE-3 may be configured as DLAs and server 152 may be configured as an SCA, in one implementation. In such a case, routers CE-2 and CE-3 may monitor traffic flows, router states (e.g., queues, routing tables, etc.), or any other conditions that may be indicative of an anomaly in network 100. As would be appreciated, any number of different types of network devices may be configured as a DLA (e.g., routers, switches, servers, blades, etc.) or as an SCA.

Assume, for purposes of illustration, that CE-2 acts as a DLA that monitors traffic flows associated with the devices of local network 160 (e.g., by comparing the monitored conditions to one or more machine-learning models). For example, assume that device/node 10 sends a particular traffic flow 302 to server 154 (e.g., an application server, etc.). In such a case, router CE-2 may monitor the packets of traffic flow 302 and, based on its local anomaly detection mechanism, determine that traffic flow 302 is anomalous. Anomalous traffic flows may be incoming, outgoing, or internal to a local network serviced by a DLA, in various cases.

In some cases, traffic 302 may be associated with a particular application supported by network 100. Such applications may include, but are not limited to, automation applications, control applications, voice applications, video applications, alert/notification applications (e.g., monitoring applications), communication applications, and the like. For example, traffic 302 may be email traffic, HTTP traffic, traffic associated with an enterprise resource planning (ERP) application, etc.

In various embodiments, the anomaly detection mechanisms in network 100 may use Internet Behavioral Analytics (IBA). In general, IBA refers to the use of advanced analytics coupled with networking technologies, to detect anomalies in the network. Although described later with greater details, the ability to model the behavior of a device (networking switch/router, host, etc.) will allow for the detection of malware, which is complementary to the use of a firewall that uses static signatures. Observing behavioral changes (e.g., a deviation from modeled behavior) thanks to aggregated flows records, deep packet inspection, etc., may allow detection of an anomaly such as an horizontal movement (e.g. propagation of a malware, etc.), or an attempt to perform information exfiltration.

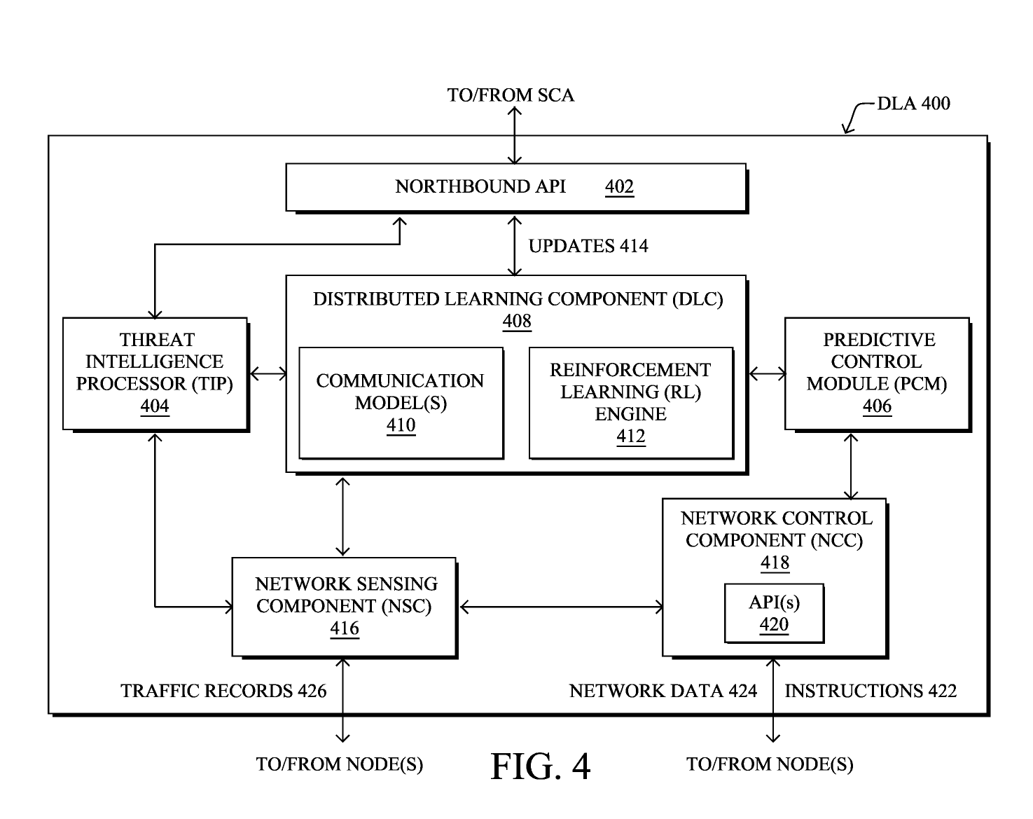

FIG. 4 illustrates an example distributed learning agent (DLA) 400 in greater detail, according to various embodiments. Generally, a DLA may comprise a series of modules hosting sophisticated tasks (e.g., as part of an overall SLN process 248). Generally, DLA 400 may communicate with an SCA (e.g., via one or more northbound APIs 402) and any number of nodes/devices in the portion of the network associated with DLA 400 (e.g., via APIs 420, etc.).

In some embodiments, DLA 400 may execute a Network Sensing Component (NSC) 416 that is a passive sensing construct used to collect a variety of traffic record inputs 426 from monitoring mechanisms deployed to the network nodes. For example, traffic record inputs 426 may include Cisco™ Netflow records, application identification information from a Cisco™ Network Based Application Recognition (NBAR) process or another application-recognition mechanism, administrative information from an administrative reporting tool (ART), local network state information service sets, media metrics, or the like.

Furthermore, NSC 416 may be configured to dynamically employ Deep Packet Inspection (DPI), to enrich the mathematical models computed by DLA 400, a critical source of information to detect a number of anomalies. Also of note is that accessing control/data plane data may be of utmost importance, to detect a number of advanced threats such as data exfiltration. NSC 416 may be configured to perform data analysis and data enhancement (e.g., the addition of valuable information to the raw data through correlation of different information sources). Moreover, NSC 416 may compute various networking based metrics relevant for the Distributed Learning Component (DLC) 408, such as a large number of statistics, some of which may not be directly interpretable by a human.

In some embodiments, DLA 400 may also include DLC 408 that may perform a number of key operations such as any or all of the following: computation of Self Organizing Learning Topologies (SOLT), computation of “features” (e.g., feature vectors), advanced machine learning processes, etc., which DLA 400 may use in combination to perform a specific set of tasks. In some cases, DLC 408 may include a reinforcement learning (RL) engine 412 that uses reinforcement learning to detect anomalies or otherwise assess the operating conditions of the network. Accordingly, RL engine 412 may maintain and/or use any number of communication models 410 that model, e.g., various flows of traffic in the network. In further embodiments, DLC 408 may use any other form of machine learning techniques, such as those described previously (e.g., supervised or unsupervised techniques, etc.). For example, in the context of SLN for security, DLC 408 may perform modeling of traffic and applications in the area of the network associated with DLA 400. DLC 408 can then use the resulting models 410 to detect graph-based and other forms of anomalies (e.g., by comparing the models with current network characteristics, such as traffic patterns. The SCA may also send updates 414 to DLC 408 to update model(s) 410 and/or RL engine 412 (e.g., based on information from other deployed DLAs, input from a user, etc.).

When present, RL engine 412 may enable a feedback loop between the system and the end user, to automatically adapt the system decisions to the expectations of the user and raise anomalies that are of interest to the user (e.g., as received via a user interface of the SCA). In one embodiment, RL engine 412 may receive a signal from the user in the form of a numerical reward that represents for example the level of interest of the user related to a previously raised event. Consequently the agent may adapt its actions (e.g. search for new anomalies), to maximize its reward over time, thus adapting the system to the expectations of the user. More specifically, the user may optionally provide feedback thanks to a lightweight mechanism (e.g., ‘like’ or ‘dislike’) via the user interface.

In some cases, DLA 400 may include a threat intelligence processor (TIP) 404 that processes anomaly characteristics so as to further assess the relevancy of the anomaly (e.g. the applications involved in the anomaly, location, scores/degree of anomaly for a given model, nature of the flows, or the like). TIP 404 may also generate or otherwise leverage a machine learning-based model that computes a relevance index. Such a model may be used across the network to select/prioritize anomalies according to the relevancies.

DLA 400 may also execute a Predictive Control Module (PCM) 406 that triggers relevant actions in light of the events detected by DLC 408. In order words, PCM 406 is the decision maker, subject to policy. For example, PCM 406 may employ rules that control when DLA 400 is to send information to the SCA (e.g., alerts, predictions, recommended actions, trending data, etc.) and/or modify a network behavior itself. For example, PCM 406 may determine that a particular traffic flow should be blocked (e.g., based on the assessment of the flow by TIP 404 and DLC 408) and an alert sent to the SCA.

Network Control Component (NCC) 418 is a module configured to trigger any of the actions determined by PCM 406 in the network nodes associated with DLA 400. In various embodiments, NCC 418 may communicate the corresponding instructions 422 to the network nodes using APIs 420 (e.g., DQoS interfaces, ABR interfaces, DCAC interfaces, etc.). For example, NCC 418 may send mitigation instructions 422 to one or more nodes that instruct the receives to reroute certain anomalous traffic, perform traffic shaping, drop or otherwise “black hole” the traffic, or take other mitigation steps. In some embodiments, NCC 418 may also be configured to cause redirection of the traffic to a “honeypot” device for forensic analysis. Such actions may be user-controlled, in some cases, through the use of policy maps and other configurations. Note that NCC 418 may be accessible via a very flexible interface allowing a coordinated set of sophisticated actions. In further embodiments, API(s) 420 of NCC 418 may also gather/receive certain network data 424 from the deployed nodes such as Cisco™ OnePK information or the like.

The various components of DLA 400 may be executed within a container, in some embodiments, that receives the various data records and other information directly from the host router or other networking device. Doing so prevents these records from consuming additional bandwidth in the external network. This is a major advantage of such a distributed system over centralized approaches that require sending large amount of traffic records. Furthermore, the above mechanisms afford DLA 400 additional insight into other information such as control plane packet and local network states that are only available on premise. Note also that the components shown in FIG. 4 may have a low footprint, both in terms of memory and CPU. More specifically, DLA 400 may use lightweight techniques to compute features, identify and classify observation data, and perform other functions locally without significantly impacting the functions of the host router or other networking device.

—Adaptive Anomaly Forwarding in Distributed Anomaly Detection Systems—

Distributed learning systems such as SLNs generally detect anomalies independently of the network resources that are available for sending the information about these anomalies to the centralized agent (e.g., SCA) and/or the user operating the system. This can lead to the situation where a large volume of statistical deviations detected by the system can overload a network resource (e.g., WAN bandwidth, etc.). For this reason, it is important to limit the number of anomalies that are reported per unit of time, while prioritizing those anomalies that are expected to be of more importance or relevance.

The techniques herein specify an approach for distributed anomaly detection systems that is fully adaptive, distributed, and scalable for selecting the most interesting anomalies so as to satisfy certain configured limitations in terms of consumed resources such as the available network constraints. Said differently, the techniques herein introduce a fully distributed, adaptive, and scalable system for limiting the rate of anomalies that are forwarded by the different components of a distributed learning system. In some aspects, the rate limitation may take into account the characteristics of the detected anomaly (e.g., score, cost of forwarding, etc.), the available resources (e.g., network bandwidth, user attention, etc.), and policies and safeguards installed in the system. This results in a system that uses available network resources optimally, to report detected anomalies.

Illustratively, the techniques described herein may be performed by hardware, software, and/or firmware, such as in accordance with the SLN process 248, which may include computer executable instructions executed by the processor 220 (or independent processor of interfaces 210) to perform functions relating to the techniques described herein, e.g., in conjunction with routing process 244.

Specifically, according to various embodiments, a device in a network monitors a selective anomaly forwarding mechanism deployed in the network. The selective anomaly forwarding mechanism causes a participating node in the mechanism to selectively forward detected network anomalies to the device. The device monitors one or more resources of the network. The device determines an adjustment to the selective anomaly forwarding mechanism based on the one or more monitored resources of the network. The device implements the determined adjustment to the selective anomaly forwarding mechanism.

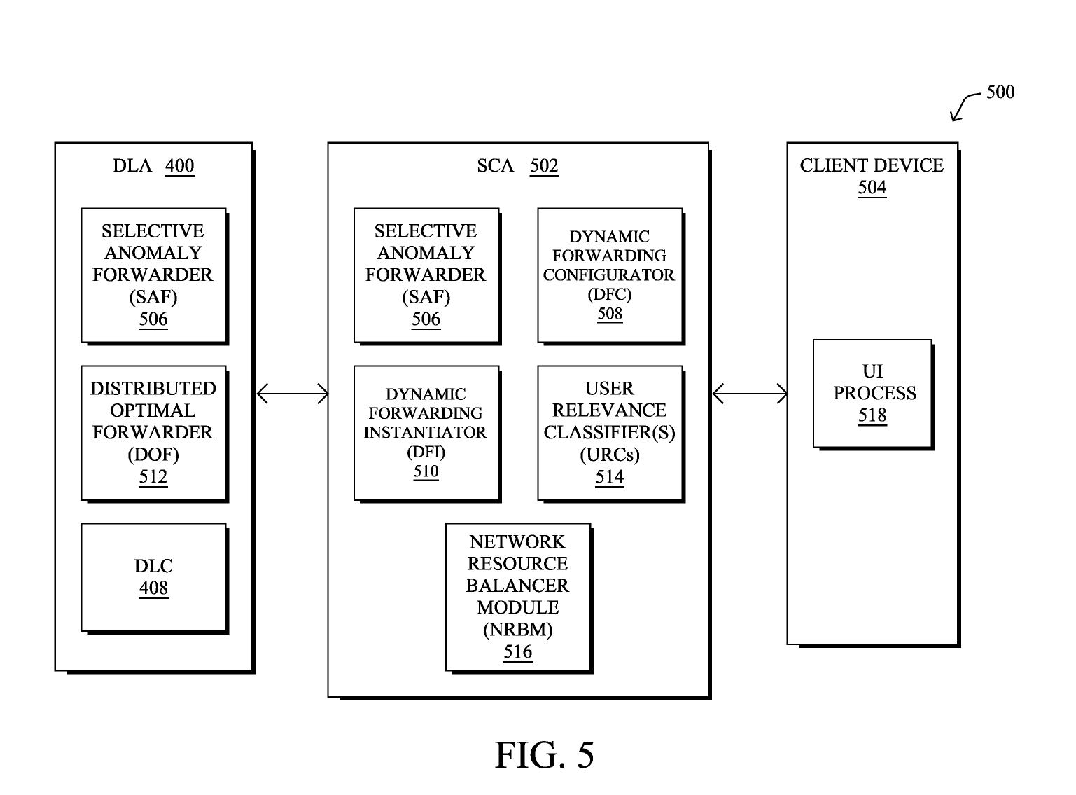

Operationally, FIG. 5 illustrates an example architecture 500 for adjusting anomaly detection operations based on network resources, in accordance with various embodiments herein. One aspect of the techniques herein illustratively involves a remote learning agent that is equipped with a machine learning-based anomaly detection engine, such as DLA 400 shown. Notably, the anomaly detection engine (e.g., DLC 408) may use a set of machine learning models, to detect anomalies at the edge of a local network. For example, DLC 408 may employ an unsupervised machine learning-based anomaly detector that identifies statistical deviations in the characteristics of the network traffic.

As described above, architecture 500 may also include an SCA 502 that provides supervisory control over DLA 400 and receives notification of any of the anomalies detected by DLA 400. In turn, SCA 502 may report the detected anomalies to a user interface (UI) process 518, which may be executed by a client device 504 in communication with SCA 502 or direction on SCA 502. Notably, SCA 502 may generate visualizations for display by UI process 518, thereby allowing an administrator or other user to review the anomaly detection mechanisms in the network and any detected anomalies. In response, the user may provide feedback via UI process 518 regarding any detected anomalies and/or the reporting mechanism to SCA 502. The user may also provide, via UI process 518, other configurations, settings, or the like, to SCA 502, to adjust the operation of the SLN.

One aspect of the techniques herein introduces a Selective Anomaly Forwarder (SAF) 506. This component is in charge of collecting anomalies detected by one or more DLAs, such as DLA 400. Then, based on the characteristics of the anomalies, its configuration and the current network conditions, SAF 506 decides which anomalies to forward to the next level in the distributed learning system. Indeed, when an anomaly is detected by a DLA, it assigns a score to this anomaly, that is, a measure of how anomalous the event is (the higher the score, the more anomalous the event). Then, this anomaly is forwarded to the next level in the distributed learning system, which might be another SAF. Notably, as shown in architecture 500, either or both of DLA 400 and SCA 502 may execute a corresponding SAF 506. When executed on DLA 400, SAF 506 may control whether DLA 400 forwards an anomaly detected by DLC 408 to SCA 502. Similarly, when SAF 506 is executed on SCA 502, SAF 506 may control whether SCA 502 forwards a detected anomaly to UI process 518 for presentation to the user.

When a SAF 506 receives an indication of a newly detected anomaly, it may perform any or all of the following operations:
1. Add the anomaly to the list of received anomalies.
2. Remove anomalies that are older than N minutes, with N being a configurable parameter (for instance, N=1440 for configuring 1 day).
3. Sort in decreasing order the list of anomalies according to their anomaly score.
4. Compute:
   a) the global_rank of the new anomaly, which is its rank in the whole list of anomalies; and
   b) the dla_rank of the new anomaly, which is its rank in the list only considering anomalies detected by the same DLA that generated the new anomaly. Note that for SAFs receiving anomalies from a single DLA or executed locally by a DLA, both ranks are always the same. Hence, this type of SAF do not need compute the dla_rank.
5. Compute the cost of forwarding the anomaly. In its simplest embodiment, the cost is simply the size of the anomaly message, but it can also be some sort of user cost for handling this anomaly (for SAFs located in SCA 502, see below).
6. Compute the available budget. In general, this budget will be the available bandwidth computed, for instance, as the available bandwidth for the last N minutes (see step 2 above) minus the bandwidth consumed by all the anomalies forwarded in the past. However, for SAFs located in SCA 502, this budget can be in terms of the number of anomalies that can be forwarded to users. Note that in highly distributed anomaly detection system, the available network resources are likely to be one of key constraints when forwarding anomalies to a central controller, SCA 502.
7. Compute restrictions related to policies (e.g., always forward anomalies related to DNS traffic, etc.), safeguards (e.g., never forward/report more than 10 anomalies per minute), etc.
8. Decide whether to forward or not the anomaly according to the rank(s) and the values computed in steps 5, 6 and 7 above. Two modes of operation are introduced for step 8:
   a) Deterministic Operation Mode (DOM). In this mode of operation, SAF 506 computes the maximum top-N anomalies (maximum rank) that could be forwarded for satisfying the budget constraints. If the new anomaly is in the top-N, and the restrictions, safeguards, etc. computed in step 7 do not block this anomaly from being reported, the anomaly is forwarded. Otherwise, the anomaly is discarded.
   b) Probabilistic Operation Mode (POM). In this mode of operation, the SAF fits a probabilistic function to the rank distributions (global_rank and dla_rank), for instance, using an exponential distribution function. If a sampling according to this distribution chooses the newly received/detected anomaly, the budget allows for forwarding the anomaly and the restrictions computed in step 7 (e.g., safeguards, etc.) do not block this anomaly, the anomaly is forwarded. Otherwise, the anomaly is discarded. Note that several sampling strategies can be adopted. For instance, compute the value of the cumulative distribution function for the rank value of interest (c) and choose a random value from a uniform [0,1] distribution (u). Then, the sampling chooses the anomaly if and only if c<u.

According to the techniques herein, SAFs 506 can be located at three different points of the distributed learning system, corresponding to as many embodiments of this component. Indeed, SAFs 506 can be co-located with a DLA 400, with the centralized agent, SCA 502, or with an intermediate network element in the data path between SCA 502 and one or more DLAs 400.

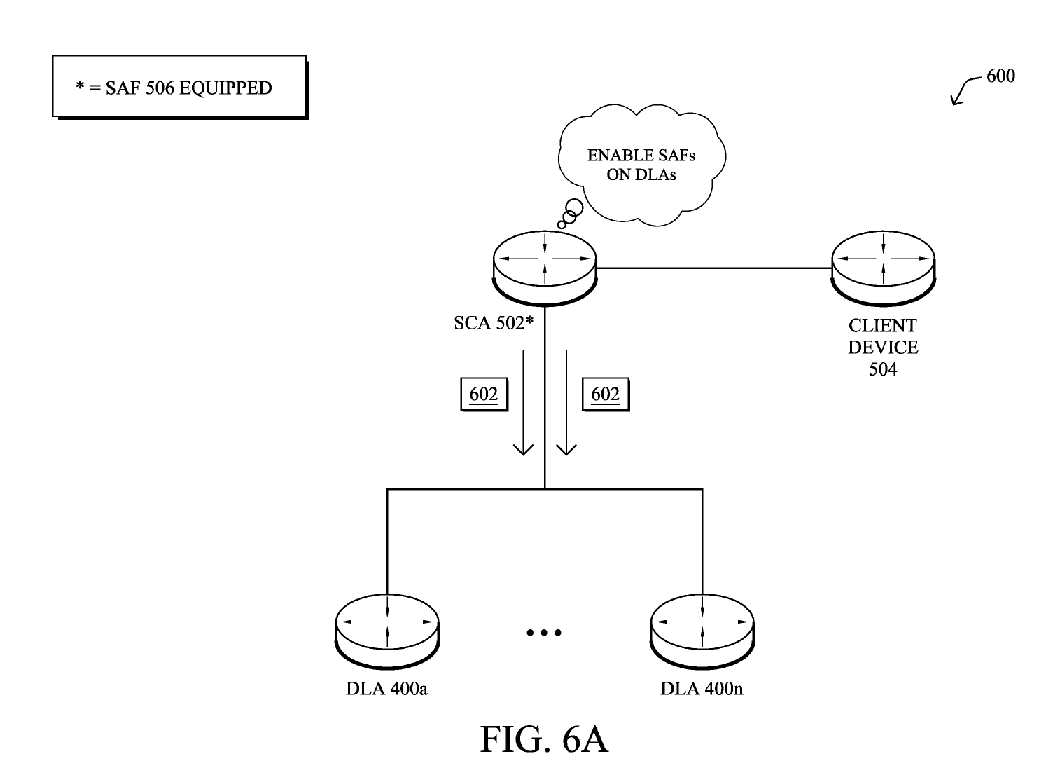

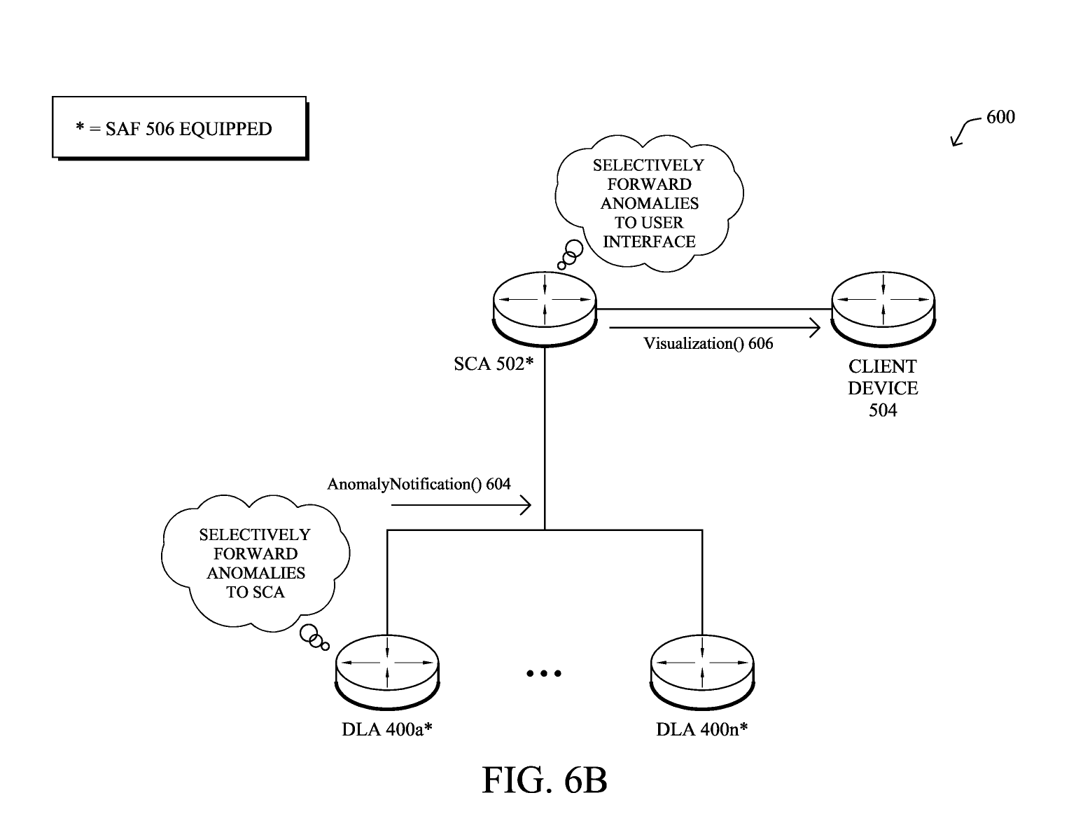

FIGS. 6A-6B illustrate an example of the selective forwarding of anomalies using SAFs 506 in the network, according to various embodiments. In FIG. 6A, SCA 502 may provide supervision over DLAs 400a-400n (e.g., a first through nth DLA 400. As shown, SCA 502 may enable SAFs 506 on any or all of DLAs 400a-400n via control messages 602. In various embodiments, control messages 602 may include SAFs 506 themselves (e.g., to install an SAF 506 to a particular DLA) or configuration parameters, if an SAF 506 is already enabled on the receiving DLA 400. Such configuration parameters may include any of the parameters listed above, such as the timeout parameter N, parameters that control the resource budget of the DLA, parameters that control the cost function or anomaly ranks, policies or safeguards, or the like.

In one embodiment, as shown in FIG. 6B, an SAF 506 may be enabled on any or all of DLAs 400a-400n. In this case, SAF 506 may collect the anomalies detected by the local learning agent (e.g., DLC 408) and decide which anomalies should be forwarded to the next level in the distributed learning system. For example, assume that DLA 400a detects a network anomaly. In such a case, the local SAF 506 of DLA 400a may determine whether or not to report/forward the detected anomaly to the next level of the SLN via an AnomalyNotification( ) message 604. In various embodiments, the next level of the SLN can be an intermediate SAF 506 (e.g., as described below) or the centralized controller, such as SCA 502. Note that in this embodiment, SAF 506 on DLAs 400a-400n will only compute the global_rank, since the dla_rank is not needed when executed locally on a DLA.

Also as shown, assume that SCA 502 is also equipped with an SAF 506. In such a case, the local SAF 506 of SCA 502 may gather the anomalies reported to SCA 502 by DLAs 400a-400n via AnomalyNotification( ) messages 604 and select which of the reported/forwarded anomalies should be sent to UI process 518 of client device 504, using the steps described previously. In turn, SCA 502 may include only the selected anomalies in Visualization( ) data 606 sent to UI process 518 for presentation to the user. In other words, SAF 506 on SCA 502 may locally add yet another forwarding/reporting filter to the SLN, thereby notifying the user of only the most relevant or interesting anomalies.

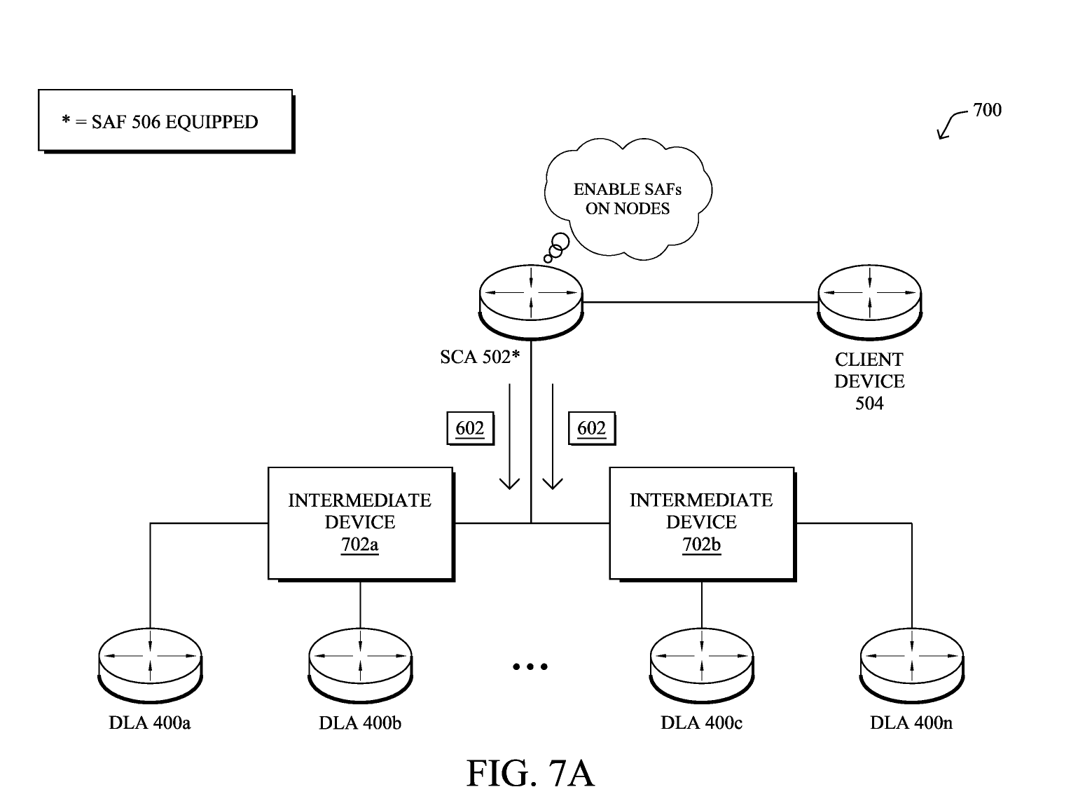

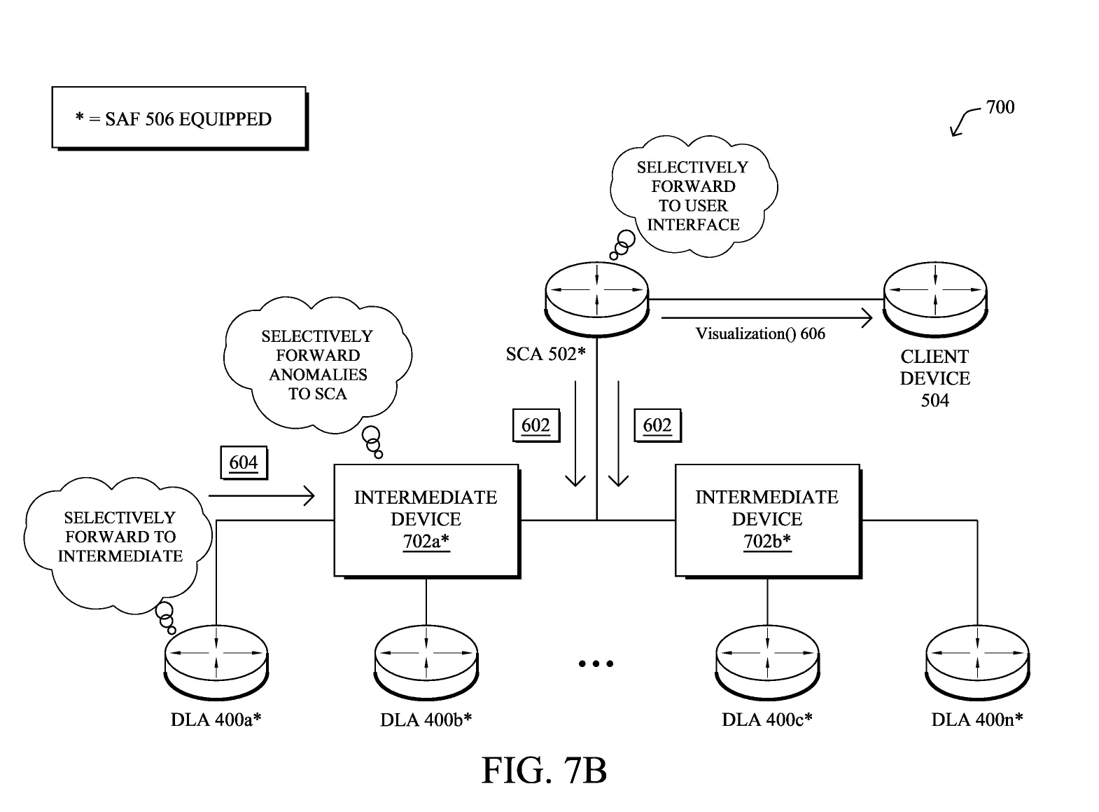

FIGS. 7A-7B illustrate another example of the selective forwarding of anomalies, in accordance with further embodiments. As shown in FIG. 7A, assume that there exist intermediate network elements/devices 702a-702b between SCA 502 and at least some of DLAs 400a-400n. For example, intermediate device 702a may be in the path between SCA 502 and DLAs 400a-400b.

Similar to the example of FIG. 6A, SCA 502 may opt to enable SAF 506 on any of DLAs 400a-400n for local filtering of the detected anomalies. In addition, as shown in FIG. 7A, SCA 502 may opt to enable an SAF 506 on any of intermediate devices 702a-702b, either in addition to DLAs 400a-400n or in lieu thereof. In this case, the SAF aggregates the anomalies forwarded by several DLAs (each one potentially running a SAF) and decides which ones should be forwarded to the next level in the distributed learning system. The next level can be another intermediate SAF or the centralized agent.

As shown in FIG. 7B, assume that SAF 506 is enabled on intermediate device 702a, to provide filtering of anomalies detected by DLAs 400a-400b. If DLA 400a then detects an anomaly, it may send an AnomalyNotification( ) message 604 to intermediate device 702a, either automatically or selectively, if SAF 506 is also enabled on DLA 400a. In turn, SAF 506 of intermediate device 700a may aggregate the anomalies reported/forwarded by DLAs 400a-400b and selectively send the anomalies to SCA 502. Note that in this case, SAF 506 on intermediate device 702a may compute both the global_rank and the dla_rank, as described above.

The location for the intermediate SAFs 506 may be governed and dynamically computed by SCA 502 according to the network resources in the network, in some embodiments. For example, in highly constrained networks, it may be desirable to locate an intermediate SAF 506 to aggregate or select the anomalies of greatest interest for forwarding, according to the network resources (e.g., typically at choke points/bottlenecks in the network).

Also as shown in FIG. 7A, the centralized agent, SCA 502 may also execute an SAF 506, in addition to, or in lieu of, those executed by DLAs 400a-400n and/or intermediate devices 702a-702b. In this case, the SAF 506 local to SCA 502 may collect and assess the anomalies reported to SCA 502 via intermediate devices 702a-702b for inclusion in Visualization( ) data 606 sent by SCA 502 to UI process 518 for presentation to the user. In this embodiment, the local SAF 506 of SCA 502 can also compute global_rank and dla_rank, to select which of the anomalies are shown.

Referring again to FIG. 5, another aspect of the techniques herein is Dynamic Forwarding Configurator (DFC) 508. Generally, DFC 508 is in charge of dynamically configuring the parameters of SAFs 506 (e.g., via messages 602). The objective of this dynamic configuration is to maintain a maximum performance of the distributed learning system while respecting certain operation limits. This component is usually co-located within SCA 502, allowing DFC 508 to have access to all the information about the distributed learning system. However, in other embodiments, DFC 508 can be located elsewhere and access this data through public APIs of SCA 502. For configuring the SAFs 506, DFC 508 may send a unicast or multicast configuration message 602 to the involved SAFs 506 with any or all of the following information:
Size of the time window of the list of anomalies (e.g., 1 day).
Type of cost to be considered for the anomalies, for instance the bandwidth.
Available budget (e.g., 20 MB). In one embodiment the bandwidth may be static whereas, in another embodiment, the bandwidth is dynamically computed according to the available network resources in the network.
Policies to be applied if any (e.g., “always forward anomalies related to DNS traffic,” etc.).
Safeguards to be applied, if any (e.g., “never forward more than 10 anomalies in one minute,” etc.).
Destination of the anomalies that are selected for forwarding.

An additional aspect of the techniques herein is a Dynamic Forwarder Instantiator (DFI) 510. This component is in charge of dynamically instantiating/activating SAFs 506 in bottleneck points in the network. Indeed, several DLAs 400 can be distributed across a campus area network (CAN), where high-speed communications are available, but SCA 502 may be located in a different network only reachable through a low-speed WAN. In this case, it is more efficient and robust to use very permissive SAFs 506 in the DLAs, and then to place a stricter SAF 506 at the output of the CAN. For instance, imagine that three DLAs are located in the same high-speed network and detect the following anomalies (remember, the higher the score, the more anomalous the event is):
Agent 1: Two anomalies detected with scores 10 and 8 in time window “W”;
Agent 2: Two anomalies detected with scores 2 and 1 in time window W;
Agent 3: Two anomalies detected with scores 9 and 3 in time window W;

If SAFs 506 are only running on the distributed agents and the system can afford only three anomalies (e.g., due to WAN constraints) between the SAFs 506 and SCA 502 during the time window W, the best configuration is to allow one anomaly per distributed agent in the time window W. This approach would forward the anomalies with scores 10 (agent 1), 2 (agent 2) and 9 (agent 3), which is a suboptimal solution. Nevertheless, if an intermediate SAF 506 is instantiated at the edge of the high-speed network, this SAF 506 would be configured to only allow three anomalies during the time window W, but the other SAFs 506 in the distributed agents could have much wider constraints, for instance 10 anomalies during the time window W. In this case, all the anomalies would be forwarded from the distributed agents to the intermediate SAF 506, which would allow it to take the correct decision of finally forwarding the anomalies with scores 10 (agent 1), 9 (agent 3) and 8 (agent 1).

DFI 510 is usually located on SCA 502, allowing it to have access to all of the information about the distributed learning system. However, in other implementations, DFI 510 may be located elsewhere and access this data through public APIs of SCA 502. During operation, DFI 510 constantly monitors the charge of the network due to the operation of the distributed learning system, and compares this data with data about the network topology and resources. When DFI 510 detects a bottleneck point that is not running a SAF 506, it checks if the network element at this point can host an SAF 506. If this is the case, DFI 506 sends an instantiation message to the target network element (e.g., instruction message 602), that must answer with a success or failure message. If the SAF 506 is successfully instantiated, DFI 510 notifies DFC 508, which will reconfigure all the SAFs 506 that are touched by the newly instantiated SAF 506.

—Adjusting Bandwidth Usage of Distributed Learning Agents Based on Anomaly Relevance—

As described above, the techniques herein may allow for the selective forwarding/reporting of detected anomalies based on the available resources in a distributed anomaly detection system. Notably, nodes may selectively forward anomalies by taking into account a reporting budget that is sensitive to the available resources in the network. The below techniques, therefore, further describe a mechanism whereby the forwarding budget allocated to a node is automatically and dynamically adjusted during the normal operation of the systems. Said differently, the techniques herein ensure dynamic bandwidth assignment across a number of forwarding nodes, based on the relevance of the events to be reported. Two key implementations are proposed: (i) a fully distributed implementation in which each selective forwarding node adapts to the implicit feedback from the SCA (e.g., pull vs. ignore anomaly) and (ii) a semi-distributed implementation in which the budget is set by a centralized component called the Network Resource Balancer Module.

Illustratively, the techniques described herein may be performed by hardware, software, and/or firmware, such as in accordance with the SLN process 248, which may include computer executable instructions executed by the processor 220 (or independent processor of interfaces 210) to perform functions relating to the techniques described herein, e.g., in conjunction with routing process 244.

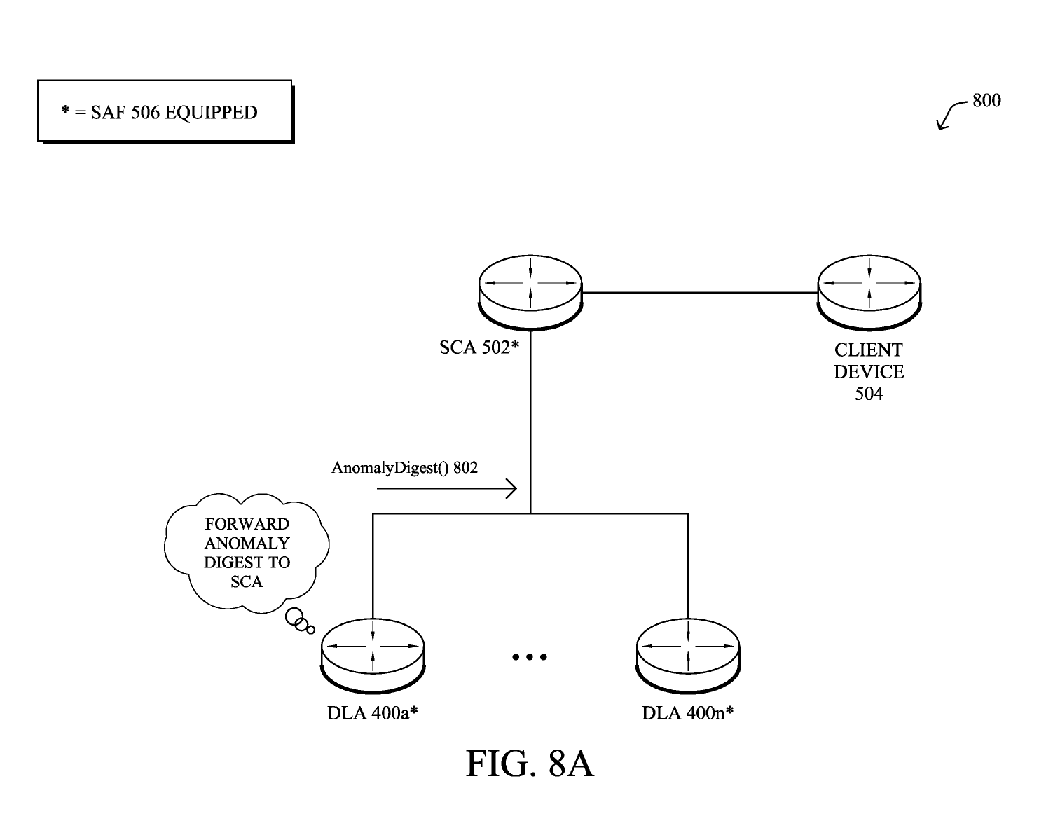

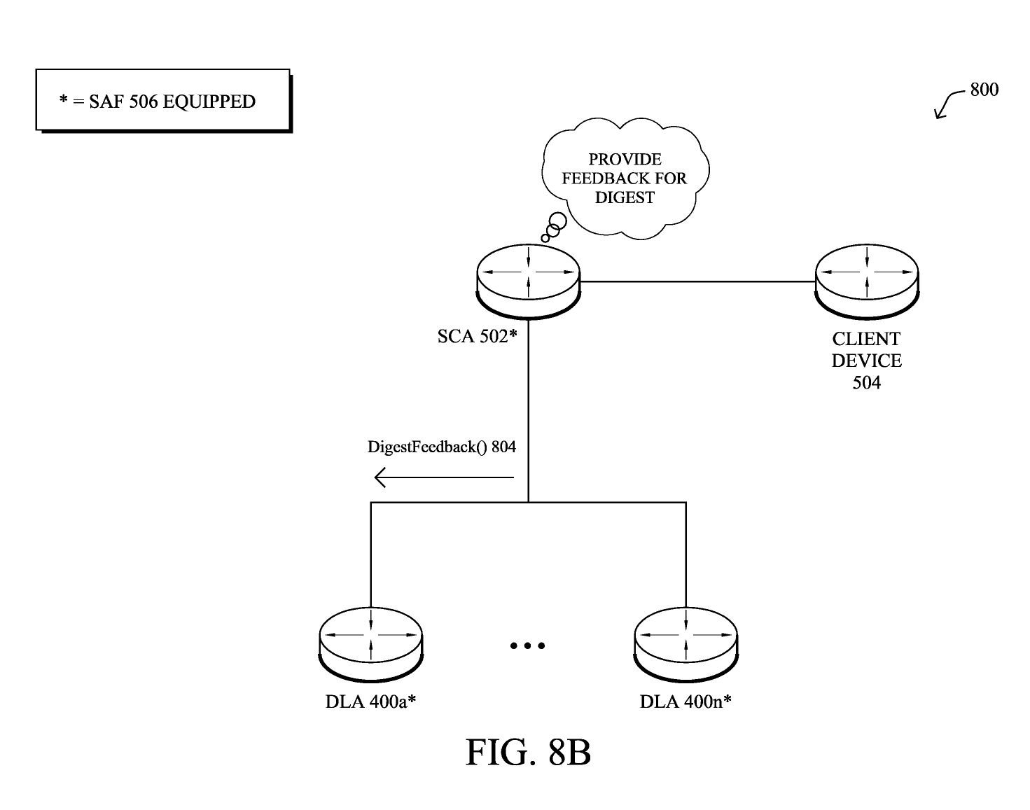

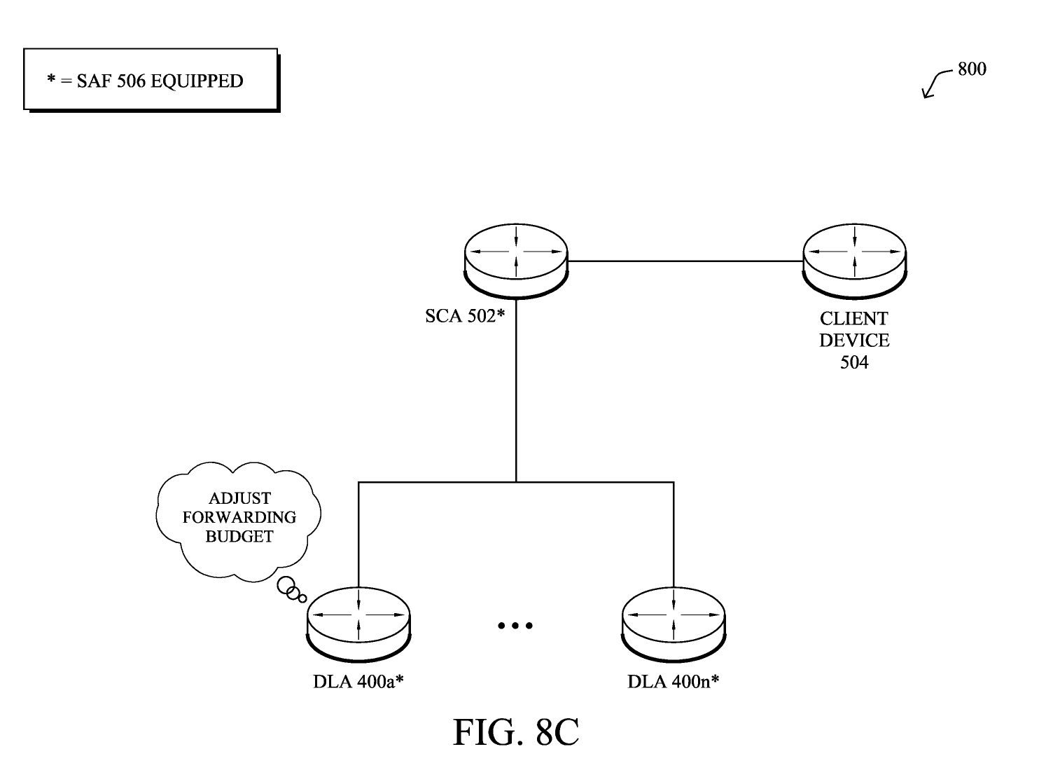

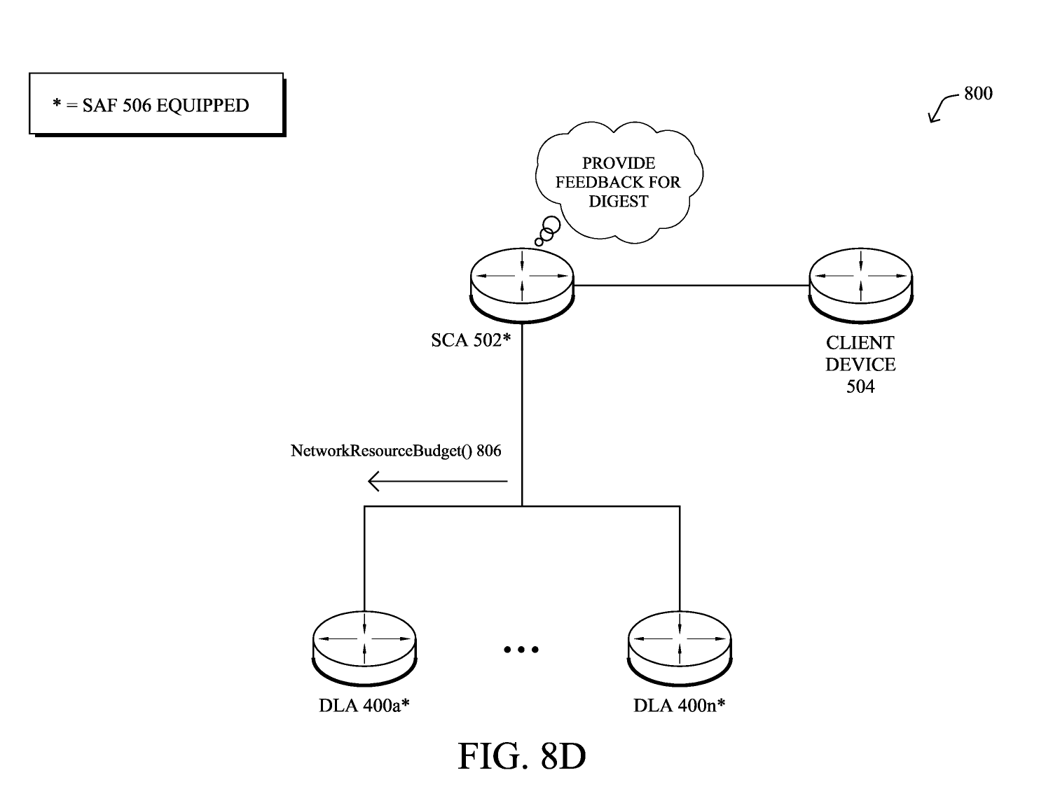

Referring again to FIG. 5, a further aspect of the techniques herein is a mechanism within DLA 400 called the Distributed Optimal Forwarder (DOF) 512 that dynamically adjusts the budget of networking resources (e.g., WAN bandwidth, router memory, etc.) based on the implicit feedback from SCA 502. This implicit feedback works as follows: whenever an anomaly is detected, DLA 400 first sends a condensed message, called a “digest,” to SCA 502. For example, as shown in FIG. 8A, if DLA 400a detects an anomaly, it may first send an AnomalyDigest( ) message 802 to SCA 502 that includes only a condensed amount of information regarding the detected anomaly. In some embodiments, if DLA 400a is also equipped with SAF 506, it may apply a similar process to select which digests to report to SCA 502, in some embodiments.

In general, an anomaly digest includes just enough information for SCA 502 to make a decision as to whether or not to display the anomaly to the user. In some embodiments, as shown in FIG. 5, SCA 502 may also leverage one or more user relevance classifiers (URCs) 514. Generally, these classifiers may be machine learning-based classifiers configured to determine whether a given anomaly is considered relevant/of interest to a user. If SCA 502 makes use of such a statistical classifier for predicting the relevance of an anomaly to the user, then the digest for anomaly “A” may include the feature vector X_{A} used by URC 514. Based on X_{A}, SCA 502 can make the decision as to whether to display the anomaly, thus requesting the complete anomaly message from DLA 400a.

Next, as shown in FIG. 8B, SCA 502 may decide whether the anomaly indicated in the digest should be displayed to the user via UI process 518 and provide feedback to DLA 400a via a DigestFeedback( ) message 804. For example, if SCA 502 determines that the user should be notified of the anomaly, message 804 may requests the complete anomaly data, which DLA 400a can interpret as a positive feedback (i.e., that the anomaly is relevant). In this case, DOF 512 may increase its allowed forwarding budget. Conversely, if feedback message 804 indicates that SCA 502 has decided not to display the detected anomaly to the user, DOF 512 of DLA 400a may reduce its allowed budget. In other words, although message 804 may be used to acknowledge the anomaly digest to request that DLA 400a send the complete data for the raised anomaly, it may also be used as a signal to perform back-pressure.

As shown in FIG. 8C, DOF 512 of DLA 400a may adjust the forwarding budget based on the feedback provided by SCA 502 via message 804. Examples strategies that DOF 512 may employ to adjust the budget based on the feedback are as follows:
1) Every positive/negative feedback may increase/decrease the budget by some factor F, with some lower/upper bounds to avoid feedback or resource starvation.
2) The budget is a predefined function (e.g., sigmoid) of the “success rate” (i.e., the proportion of anomalies that are deemed of interest).

In the semi-distributed implementation of the budget adjusting techniques, two mechanisms are introduced. First, as shown in FIG. 8D, SCA 502 may send a custom NetworkResourceBudget( ) message 806 to DLA 400a. This message describes the budget Bₜₒₜ for various network resources (e.g., WAN bandwidth, etc.) that DLA 400a is allows for purposes of reporting/forwarding anomalies to SCA 502.

Referring again to FIG. 5, another aspect of the techniques herein introduces a Network Resource Balancer Module (NRBM) 516 that is responsible for maintaining and optimizing the use of network resources across the whole network (e.g., in conjunction with DFC 508 and DFI 510). In its simplest embodiment, NRBM 516 individually adjusts the budget of each DLA 400 using a much richer set of strategies allowing for asymmetrical (unbalanced) bandwidth budget per DLA.

As mentioned above, a hierarchical approach may be taken in order to filter anomalies across the network taking into account a fixed bandwidth budget, rank of anomalies within a DLA/node, and across multiple DLAs/nodes. According to the techniques herein, the budget allocated by SCA 502 may also be unbalanced and determined by a number of parameters such as the relevance of the anomalies, the availability of network resources or other external event such as an Index of Compromise (IOC) from a threat intelligence server, or the like. Various techniques may be used to evaluate and predict anomaly relevance, e.g., using reinforcement learning with URC(s) 514.

Regarding the determination of available network resources, it is quite frequent to face network resource limitations in distributed anomaly detection systems. If SCA 502 participates in the routing domain thanks to a routing adjacency and/or can retrieve link resources using a protocol such as PCEP and/or BGP-LS, it becomes possible for SCA 502 to determine the available network resources and the network topology. If SCA 502 does have any routing adjacencies, then it can retrieve the network topology by using an API to discover network resources (e.g., to retrieve the topology from a network topology manager on an APIC, etc.). Once the topology has been retrieved, other tools in charge of evaluating the application performance in the network may be gathered (e.g., the path trace application on the APIC, etc.). Note that once the network topology along with the available network resources has been retrieved it becomes possible to identify potential bottlenecks. In the case of a typical enterprise network it is not rare to see a wide range of link-speed for remote branch offices; this is even more likely in an IoT network where DLAs may be connected using low-speed links (e.g., 3G, etc.) or even sometimes links providing intermittent connectivity (e.g. DTN).

At this point, NRBM 516 has the following information:
The network topology showing where the DLAs 400 are situated in the overall network;
The set of available network resource (using external applications computing the overall applications performance from different location of the network, or using protocol such as PCEP, BGP-LS to provide information about the states of network resource reservation); and
Statistics about each DLA 400, including the relevance of all anomalies raised, the number and the type of hosts seen, the type of applications.

Based on these data, NRBM 516 can optimize the budget allocated to each DLA 400, in order to maximize the number of relevant anomalies raised by the complete system while minimizing the impact on network resources. In one embodiment, the optimization can be performed using a meta-heuristic such as ant colony optimization. Furthermore, NRBM 502 may train a regression model (e.g., random forest, gradient boosted trees, ANNs, variational Bayesian least square, etc.), in order to predict the proportion of relevant anomalies raised by a particular DLA 400 based on its properties (e.g., location in the network, type and breakdown of applications, hosts, etc.). Hence, when a new DLA is deployed, NRBM 516 can directly optimize its budget without having to wait for it to raise anomalies.

In another embodiment, NRBM 516 may use additional sources of information to adjust the network resource allocation strategies. For instance, NRBM 516 may temporarily increase the budget of one or more DLAs, in case of the emergence of new intrusions (e.g., obtained from threat intelligence feeds) and/or the occurrence of special events (e.g., the system may increase the budget of DLAs monitoring retail stores during Black Friday).

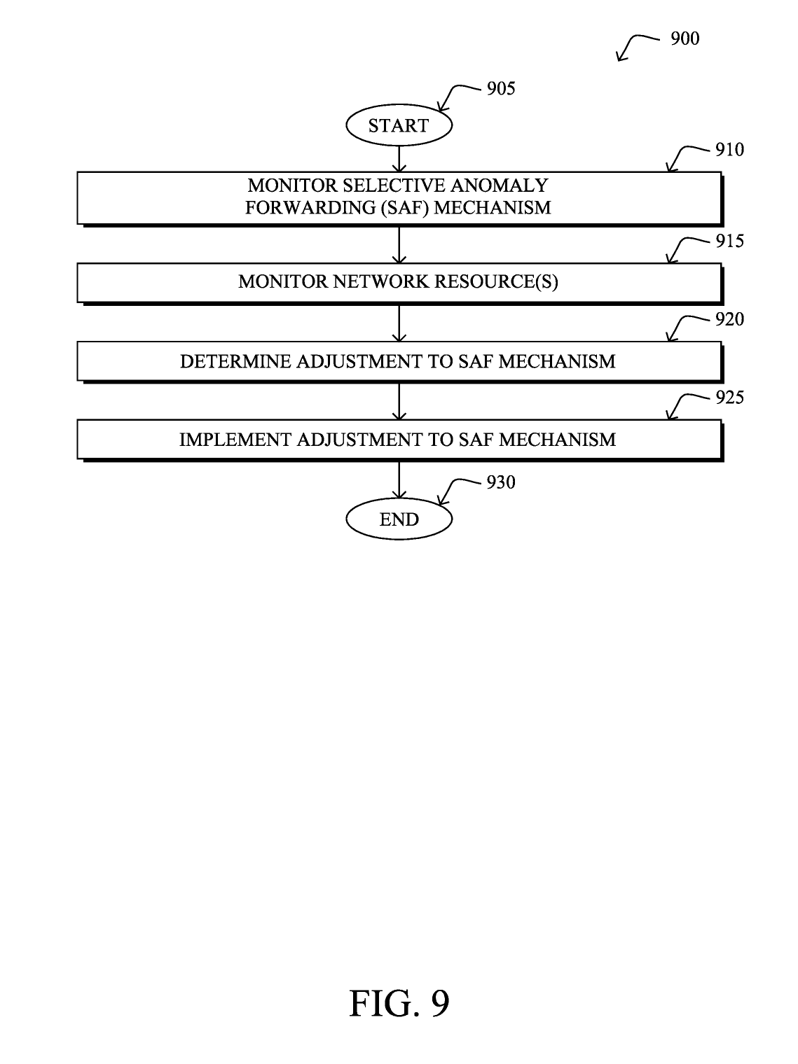

FIG. 9 illustrates an example simplified procedure for adjusting anomaly detection operating based on network resources, in accordance with various embodiments herein. Procedure 900 may be performed by a specialized device in a network, such as an SCA or other supervisory controller in an SLN. Procedure 900 may start at step 905 and continue on to step 910 where, as described in greater detail above, the device may monitor a selective anomaly forwarding mechanism in the network. Such a mechanism may cause a participating node in the mechanism to selectively forward detected network anomalies to the device. In various embodiments, the participating node may be a DLA that locally detects the anomaly (e.g., using a machine learning-based anomaly detector) or may be an intermediate node between such a DLA and the device.

At step 915, as detailed above, the device may monitor one or more network resources. For example, the device may monitor the bandwidth available to each of the participants in the selective anomaly forwarding mechanism for purposes of reporting anomalies in the network.

At step 920, the device may determine an adjustment to the selective anomaly forwarding mechanism based on the monitored network resource(s), as described in greater detail above. Such an adjustment may correspond to instituting a new participant in the mechanism (e.g., at a network bottleneck), removing a current participant from the mechanism, or adjusting one or more parameters of an existing participant. For example, the device may decide to adjust a reporting budget used by the participant to control the number of reported anomalies or bandwidth consumption in any given time frame. Further exemplary adjustments may include a forwarding cost used by the participant to select an anomaly for forwarding, a time window during which the participant is to forward an anomaly, or a forwarding destination to which the participant is to forward an anomaly. In another example, the adjustment may correspond to feedback from the device to the participant regarding the relevancy of an anomaly to a user.

At step 925, as detailed above, the device may implement the determined adjustment to the selective anomaly forwarding mechanism. For example, the device may send an instruction or feedback to one or more participants in the mechanism, to cause the receiver(s) to affect the changes. For example, if the device deems a forwarded anomaly irrelevant to the user, the device may provide feedback to the participant to cause the participant to suppress similar anomalies in the future.

It should be noted that while certain steps within procedure 900 may be optional as described above, the steps shown in FIG. 9 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, provide for adaptive anomaly forwarding in distributed anomaly detection systems, such as SLNs. In particular, the techniques herein provide a fully adaptive and scalable mechanism for limiting the number of anomalies that the distributed learning system detects and forwards up to the user. Through tight integration between networking-related constraints and machine learning-based anomaly characterization, the techniques select messages to be sent in order not to exceed a given threshold (e.g., a networking-level constraint) and to choose which messages to forward based on their anomaly score and/or more sophisticated machine learning-based criteria. As such, the techniques cover a fully distributed forwarding mechanism that take into account a wide number of constraints such as network resources that limits the rate of anomalies for assuring an optimal system performance and user experience.

The techniques described herein, therefore, also provide for the adjustment of bandwidth usage by DLAs based on anomaly relevance. In particular, the techniques herein allow for a much more adaptive use of network resources in the context of IBA, as well as much higher scalability. That is, the bandwidth budget for each anomaly forwarding component is tuned according to its network location and the potential relevance of the anomaly it raises, thus preventing the scenario where interesting anomalies are dropped in order to leave bandwidth for anomalies which are then discarded by the system and/or user.

While there have been shown and described illustrative embodiments that provide for adaptive anomaly forwarding in distributed anomaly detection systems, as well as for adjusting bandwidth usage of distributed learning agents based on anomaly relevance, it is to be understood that various other adaptations and modifications may be made within the spirit and scope of the embodiments herein. For example, while certain embodiments are described herein with respect to using certain models for purposes of anomaly detection, the models are not limited as such and may be used for other functions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
monitoring, by a device in a network, a selective anomaly forwarding mechanism deployed in the network, wherein the selective anomaly forwarding mechanism causes a participating node in the mechanism to selectively forward detected network anomalies to the device;
monitoring, by the device, one or more resources of the network;
determining, by the device, an adjustment to the selective anomaly forwarding mechanism based on the one or more monitored resources of the network; and
implementing, by the device, the determined adjustment to the selective anomaly forwarding mechanism.

2. The method as in claim 1, wherein the participating node is a distributed learning agent configured to detect network anomalies using a machine learning-based anomaly detector.

3. The method as in claim 1, wherein the participating node is an intermediate node between the device and a distributed learning agent configured to detect network anomalies using a machine learning-based anomaly detector.

4. The method as in claim 1, further comprising:
identifying, by the device, a particular node in the network as a bottleneck based on the monitored one or more resources, wherein the adjustment to the selective anomaly forwarding mechanism comprises adding the bottleneck as a participant in the selective anomaly forwarding mechanism.

5. The method as in claim 1, wherein the determined adjustment comprises at least one of: a forwarding cost used by the participant to select an anomaly for forwarding, a time window during which the participant is to forward an anomaly, or a forwarding destination to which the participant is to forward an anomaly.

6. The method as in claim 1, wherein monitoring the selective anomaly forwarding mechanism comprises:
receiving, at the device, an anomaly reporting digest from the participant in the selective anomaly forwarding mechanism regarding a detected anomaly; and wherein implementing the determined adjustment to the selective anomaly forwarding mechanism comprises:
sending, by the device, feedback to the participant regarding the anomaly reporting digest that is indicative of whether the detected anomaly is relevant, wherein the participant uses the feedback to adjust a reporting budget used by the participant to selectively forward anomalies.

7. The method as in claim 1, further comprising:
using, by the device, a machine learning-based classifier to determine whether the detected anomaly is relevant.

8. The method as in claim 1, wherein determining the adjustment to the selective anomaly forwarding mechanism comprises:
determining, by the device, an anomaly reporting budget for a particular participant based on the one or more monitored resources of the network; and wherein implementing the determined adjustment to the selective anomaly forwarding mechanism comprises:
instructing, by the device, the particular participant to use the anomaly reporting budget to selectively forward detected anomalies.

9. The method as in claim 1, further comprising:
receiving, at the device, forwarded anomalies detected in the network; and
selectively forwarding, by the device, the received anomalies to a user interface for presentation to user based on a determined relevancy to the user.

10. An apparatus, comprising:
one or more network interfaces to communicate with a network;
a processor coupled to the network interfaces and configured to execute one or more processes; and
a memory configured to store a process executable by the processor, the process when executed operable to:
monitor a selective anomaly forwarding mechanism deployed in the network, wherein the selective anomaly forwarding mechanism causes a participating node in the mechanism to selectively forward detected network anomalies to the apparatus;
monitor one or more resources of the network;
determine an adjustment to the selective anomaly forwarding mechanism based on the one or more monitored resources of the network; and
implement the determined adjustment to the selective anomaly forwarding mechanism.

11. The apparatus as in claim 10, wherein the participating node is a distributed learning agent configured to detect network anomalies using a machine learning-based anomaly detector.

12. The apparatus as in claim 10, wherein the participating node is an intermediate node between the apparatus and a distributed learning agent configured to detect network anomalies using a machine learning-based anomaly detector.

13. The apparatus as in claim 10, wherein the process when executed is further operable to:
identify a particular node in the network as a bottleneck based on the monitored one or more resources, wherein the adjustment to the selective anomaly forwarding mechanism comprises adding the bottleneck as a participant in the selective anomaly forwarding mechanism.

14. The apparatus as in claim 10, wherein the determined adjustment comprises at least one of: a forwarding cost used by the participant to select an anomaly for forwarding, a time window during which the participant is to forward an anomaly, or a forwarding destination to which the participant is to forward an anomaly.

15. The apparatus as in claim 10, wherein the apparatus monitors the selective anomaly forwarding mechanism by:
receiving an anomaly reporting digest from the participant in the selective anomaly forwarding mechanism regarding a detected anomaly; and wherein the apparatus implements the determined adjustment to the selective anomaly forwarding mechanism by:
sending feedback to the participant regarding the anomaly reporting digest that is indicative of whether the detected anomaly is relevant, wherein the participant uses the feedback to adjust a reporting budget used by the participant to selectively forward anomalies.

16. The apparatus as in claim 10, wherein the process when executed is further operable to:
use a machine learning-based classifier to determine whether the detected anomaly is relevant.

17. The apparatus as in claim 10, wherein the apparatus determines the adjustment to the selective anomaly forwarding mechanism by:
determining an anomaly reporting budget for a particular participant based on the one or more monitored resources of the network; and wherein the apparatus implements the determined adjustment to the selective anomaly forwarding mechanism by:
instructing the particular participant to use the anomaly reporting budget to selectively forward detected anomalies.

18. The apparatus as in claim 10, wherein the process when executed is further operable to:
receive forwarded anomalies detected in the network; and
selectively forward the received anomalies to a user interface for presentation to user based on a determined relevancy to the user.

19. The apparatus as in claim 10, wherein the participant is an edge router.

20. A tangible, non-transitory, computer-readable medium storing program instructions that cause a device in a network to execute a process comprising:
monitoring, by the device, a selective anomaly forwarding mechanism deployed in the network, wherein the selective anomaly forwarding mechanism causes a participating node in the mechanism to selectively forward detected network anomalies to the device;
monitoring, by the device, one or more resources of the network;
determining, by the device, an adjustment to the selective anomaly forwarding mechanism based on the one or more monitored resources of the network; and
implementing, by the device, the determined adjustment to the selective anomaly forwarding mechanism.
